(19) United States
(12) Patent Application Publication
(10) Pub. No.: US 2014/0318619 A1
(43) Pub. Date: Oct. 30, 2014

(54) SOLAR CELL MODULE

(71) Applicant: Toyota Jidosha Kabushiki Kaisha, Toyota-shi Aichi-ken (JP)

(72) Inventor: Daisuke Sato, Susono-shi Shizuoka-ken (JP)

(73) Assignee: TOYOTA JIDOSHA KABUSHIKI KAISHA, Toyota-shi Aichi-ken (JP)

(21) Appl. No.: 14/260,366

(22) Filed: Apr. 24, 2014

(30) Foreign Application Priority Data
Apr. 26, 2013 (JP) 2013-094014

(51) Int. Cl. H01L 31/042

(52) U.S. Cl. CPC H02S 40/00
USPC 136/259

(57) ABSTRACT

A solar cell module includes a solar cell having a light-receiving surface, a liquid crystal unit disposed on one side of the solar cell so as to face the light-receiving surface, and a control unit that controls the transmittance of light in the liquid crystal unit.

### INCORPORATION BY REFERENCE

The disclosure of Japanese Patent Application No. 2013-094014 filed on Apr. 26, 2013 including the specification, drawings and abstract is incorporated herein by reference in its entirety.

### BACKGROUND OF THE INVENTION

1. Field of the Invention

The invention relates to a solar cell module.

2. Description of Related Art

In connection with a solar cell module, a power generation control system for a vehicle is known which generates electric power using solar cells installed on a sunshade on the interior side of a sun roof, as described in Japanese Patent Application Publication No. 2007-326444 (JP 2007-326444 A). The power generation control system makes it possible to uncover or cover the external appearance of the solar cells, or make the solar cells visible or invisible, through opening or closing of the sun roof.

In the meantime, a light-receiving surface of the solar cells generally assumes a dark color, so as to provide high light absorbing ability or absorbance. Therefore, it may be preferable to hide or cover the external appearance of the solar cells from an aesthetic point of view, for example. In this regard, the power generation control system as described above is able to hide or cover the appearance of the solar cells by closing the sun roof, but requires an opening/closing mechanism for that purpose.

### SUMMARY OF THE INVENTION

The invention provides a solar cell module that is able to uncover or cover the external appearance of a solar cell, without requiring any opening/closing mechanism.

A solar cell module according to one aspect of the invention includes a solar cell having a light-receiving surface, a liquid crystal unit disposed on one side of the solar cell so as to face the light-receiving surface, and a control unit that controls a transmittance of light in the liquid crystal unit.

In the solar cell module according to the above aspect of the invention, the transmittance of light in the liquid crystal unit disposed so as to face the light-receiving surface of the solar cell is controlled, namely, the transmittance is increased so as to make the light-receiving surface highly visible, and the transmittance is reduced so as to make the light-receiving surface less visible. Consequently, it is possible to uncover or cover the external appearance of the solar cell, without requiring any opening/closing mechanism.

According to the above aspect of the invention, the solar cell module that is able to uncover or cover the external appearance of the solar cell, without requiring any opening/closing mechanism, can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a solar cell module according to one embodiment of the invention;

FIG. 2 is a cross-sectional schematic view showing a principal part of the solar cell module;

FIG. 3 is a flowchart illustrating the operation of the solar cell module;

FIG. 4A and FIG. 4B are views showing the operation of the solar cell module; and

FIG. 5 is a cross-sectional schematic view showing a principal part of a solar cell module according to another embodiment of the invention.

### DETAILED DESCRIPTION OF EMBODIMENTS

Referring to the accompanying drawings, solar cell modules according to embodiments of the invention will be described in detail. In the drawings and the following description, the same reference numerals are assigned to the same elements, which will not be repeatedly described.

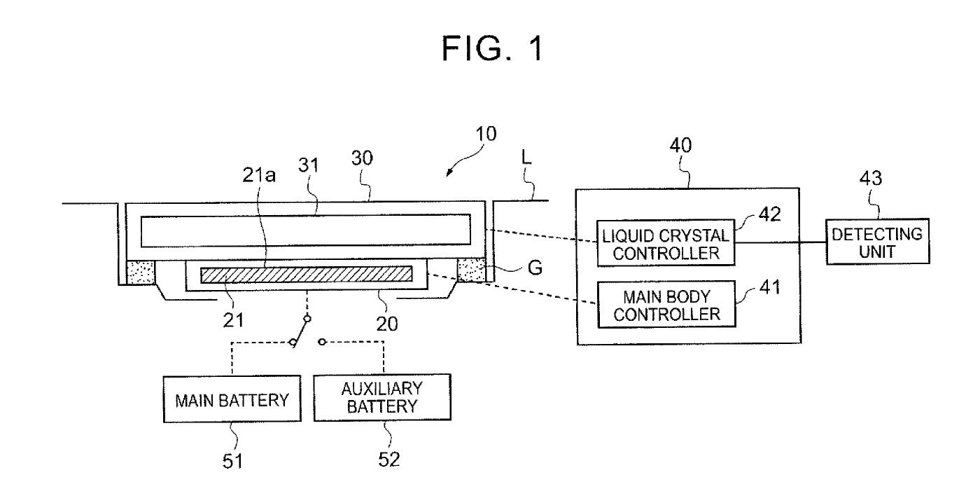

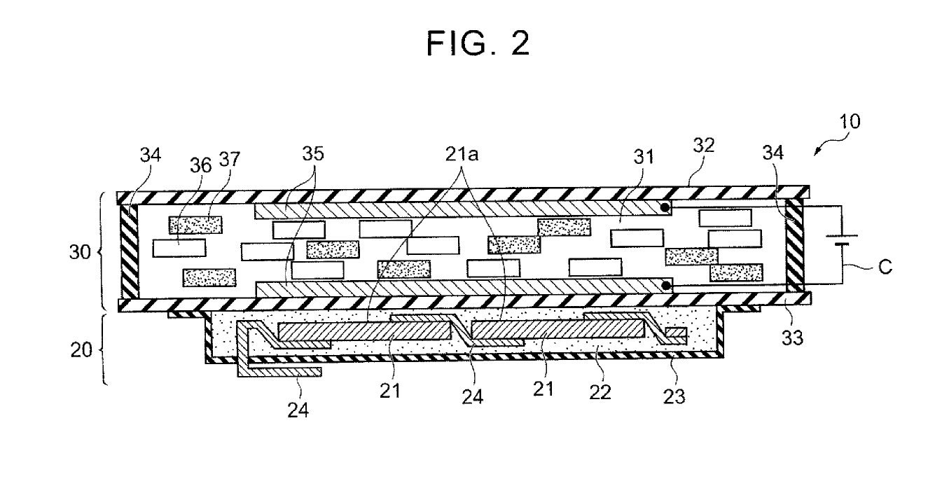

Initially, referring to FIG. 1 and FIG. 2, the configuration of a solar cell module 10 according to one embodiment of the invention will be described. The solar cell module 10 is a module including a solar cell 21 that generates electric power using sunlight.

FIG. 1 is a schematic view showing the solar cell module 10 according to the embodiment of the invention. As shown in FIG. 1, the solar cell module 10 is installed at an installation location L of an external surface of a vehicle, such as a hood, roof, trunk, door, or a fender.

The solar cell module 10 includes the solar cell 21, a liquid crystal unit 30 disposed on one side of the solar cell 21 so as to face a light-receiving surface 21a of the solar cell 21, and a control unit 40 that controls the transmittance of light in the liquid crystal unit 30.

The solar cell 21 is a cell that generates electric power by photoelectric conversion. The solar cell 21 is provided in a main body unit 20 of the solar cell module 10. A main battery 51 and an auxiliary battery 52 for storing the output or power of the cell are connected to the main body unit 20. The liquid crystal unit 30 has a liquid crystal layer 31, which is configured as a liquid crystal element, such as a liquid crystal panel. The control unit 40 is configured as a microcomputer, or the like, including a main body controller 41 and a liquid crystal controller 42.

The main body controller 41 is configured to control charge/discharge of the cell output for the main battery 51, by the MPPT (Maximum Power Point Tracking) method, for example. The main body controller 41 may also be configured to charge the auxiliary battery 52 with the cell output, so as to reduce a voltage conversion loss when the cell output is at a low level.

The liquid crystal controller 42 is configured to control supply of voltage to the liquid crystal unit 30, so as to control the transmittance in the liquid crystal unit 30 disposed on one side of the solar cell 21 so as to face the light-receiving surface 21a. Namely, the liquid crystal controller 42 increases the transmittance so as to make the light-receiving surface 21a highly visible, and reduces the transmittance so as to make the light-receiving surface 21a less visible. In this manner, the external appearance of the solar cell 21 can be uncovered or covered.

In this connection, the transmittance means the percentage of specified incident light, in particular, visible light passing through the liquid crystal unit 30. Uncovering the external appearance of the solar cell 21 means making the appearance of the solar cell 21, in particular, the light-receiving surface 21a having a relatively dark color, highly visible or noticeable, and covering the external appearance of the solar cell 21 means making the appearance of the solar cell 21, in particular, the light-receiving surface 21a, less visible or unnoticeable.

Also, the liquid crystal controller 42 is configured to control the degree of transparency of the liquid crystal unit 30. Namely, the liquid crystal controller 42 increases the degree of transparency so as to make the light-receiving surface 21a highly visible, and reduces the degree of transparency so as to make the light-receiving surface 21a less visible.

Also, the liquid crystal controller 42 controls the color of the liquid crystal unit 30 to the same or substantially the same color as that of the installation location L of the solar cell module 10. In this case, the liquid crystal unit 30 is configured to permit its color to be changed according to the transmittance. Namely, the liquid crystal controller 42 reduces the degree of similarity with the color of the installation location L so as to reduce the degree of harmony in terms of color between the liquid crystal unit 30 and the installation location L, and increases the degree of similarity so as to increase the degree of harmony. In this embodiment, the color of the installation location L means the paint color of the external surface of the vehicle in the vicinity of the installation location L of the solar cell module 10.

Also, the liquid crystal controller 42 is connected to a detecting unit 43 that detects a condition(s) and/or light receiving condition of an object on which the solar cell module 10 is installed. In this embodiment, the object on which the solar cell module 10 is installed means vehicle. The liquid crystal controller 42 controls the transmittance in the liquid crystal unit 30, based on the detection results obtained by the detecting unit 43. For example, a key sensor, ignition sensor, light sensor, and a battery sensor may be used as the detecting unit 43. The key sensor detects a locked/unlocked state of the door of the vehicle, and the ignition sensor detects the operating state of the engine. The light sensor detects the amount of ambient light around the solar cell module 10, and the battery sensor detects the remaining battery charge of the auxiliary battery 52.

The solar cell module 10 is installed in a recessed portion, or the like, formed in the external surface of the vehicle, for example, so that the liquid crystal unit 30, in particular, the external appearance of the liquid crystal unit 30, is exposed to the outside. For example, an adhesive G, such as urethane, is used for installation of the solar cell module 10.

FIG. 2 is a cross-sectional schematic view showing a principal portion of the solar cell module 10. The principal portion of the solar cell module 10 consists of the above-described main body unit 20, liquid crystal unit 30, and control unit 40. In FIG. 2, only a voltage application circuit C that constitutes the control unit 40 is schematically shown.

The main body unit 20 has at least one solar cell 21. The main body unit 20 has the solar cell(s) 21, filler 22, and a backside protective layer 23. The number of solar cells 21 connected to each other with conductors 24 is two in the embodiment shown in FIG. 2; however, the number of solar cells 21 is not limited to two.

As the solar cell 21, a Si single crystal cell, CIGS cell, or a compound-semiconductor cell may be used, for example. A compound of the compound-semiconductor cell may be selected from, for example, GaAs (gallium arsenide), InP (indium phosphide), and InGaP (indium gallium phosphide). The solar cell 21 may or may not permit light to pass therethrough.

As the filler 22, EVA (ethylene vinyl acetate), PVB (polyvinyl butyral), or ionomer may be used, for example.

As the backside protective layer 23, a PET (polyethylene terephthalate) sheet, resin sheet, or an anticorrosive steel sheet may be used, for example. The PET sheet may include metal foil. As the resin sheet, a sheet formed of PC (polycarbonate), PMMA (polymetylmethacrylate), CFRP (carbon fiber reinforced plastic), or the like, may be used.

The liquid crystal unit 30 has the above-mentioned liquid crystal layer 31 disposed on one side of the solar cells 21 so as to face the light-receiving surfaces 21a thereof. In the liquid crystal unit 30, the liquid crystal layer 31 is provided in a space that is defined by a surface protective layer 32 and a transparent substrate 33 which are opposed to each other with spacing, and sealing members 34 provided between the surface protective layer 32 and the transparent substrate 33. A pair of transparent electrodes 35, 35 are opposed to each other, such that one of the transparent electrodes 35 is disposed between the liquid crystal layer 31 and the surface protective layer 32, and the other transparent electrode 35 is disposed between the liquid crystal layer 31 and the transparent substrate 33. The transparent electrodes 35 are preferably positioned so as to cover the entire area of the light-receiving surfaces 21a of the solar cells 21 located on the backside of the liquid crystal layer 31.

As the liquid crystal layer 31, guest-host type liquid crystal cells are preferably used.

As liquid crystal molecules (host) 36, any of nematic liquid crystal, chiral nematic liquid crystal, and cholesteric liquid crystal may be used. In particular, nematic liquid crystal that can curb reduction of the transmittance is preferably used. The liquid crystal molecules 36 preferably use positive liquid crystal whose ordinary refractive index in the short-axis direction is lower than the extraordinary refractive index in the long-axis direction.

As dichroism pigment molecules (guest) 37, azo, anthraquinone, and/or dioxazine pigment molecules may be used, for example. When the color of the installation location L is other than white, the dichroism pigment molecules 37 of at least one kind, which develop color having high similarity to the color of the installation location L, are dissolved in the proportion of 0.1-10 mass % in the liquid crystal molecules 36. When the color of the installation location L is white, the dichroism pigment molecules 37 may not be dissolved.

As the surface protective layer 32, a sheet formed of a composite material mainly containing glass and fluorine resin, PET (polyethylene terephthalate), PC (polycarbonate), or PMMA (polymethylmethacrylate) may be used, for example. It is preferable that the glass has translucency, and is physically or chemically reinforced. It is also preferable that an exposed surface of the surface protective layer 32 is reinforced with hard coating, gas barrier coating, or the like.

As the transparent substrate 33, a sheet formed a composite material containing glass and fluorine resin as main components, PET (polyethylene terephthalate), PC (polycarbonate), or PMMA (polymethylmethacrylate) may be used, for example. It is preferable that the glass has translucency, and is physically or chemically reinforced.

To form the transparent electrodes 35, a transparent, electrically conductive material, such as a nesa film containing ITO (indium tin oxide) or tin oxide as a main component, is used. Microfabricated electrodes may be wired to the conductive material. The voltage application circuit C using the auxiliary battery 52 as a power supply is connected to the transparent electrodes 35.

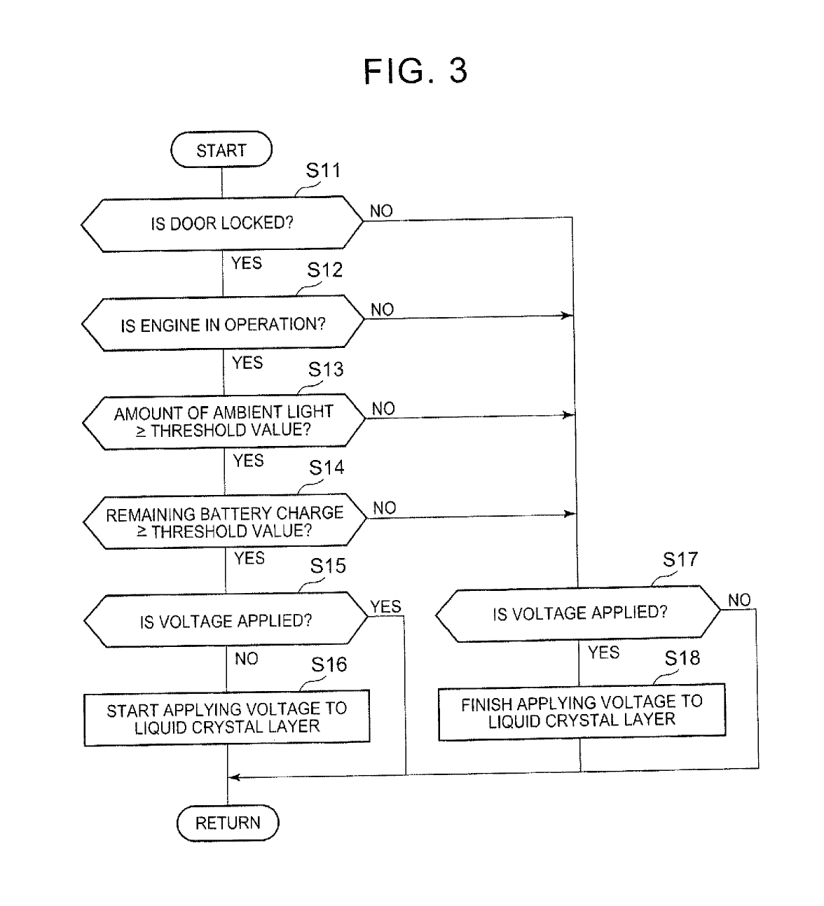

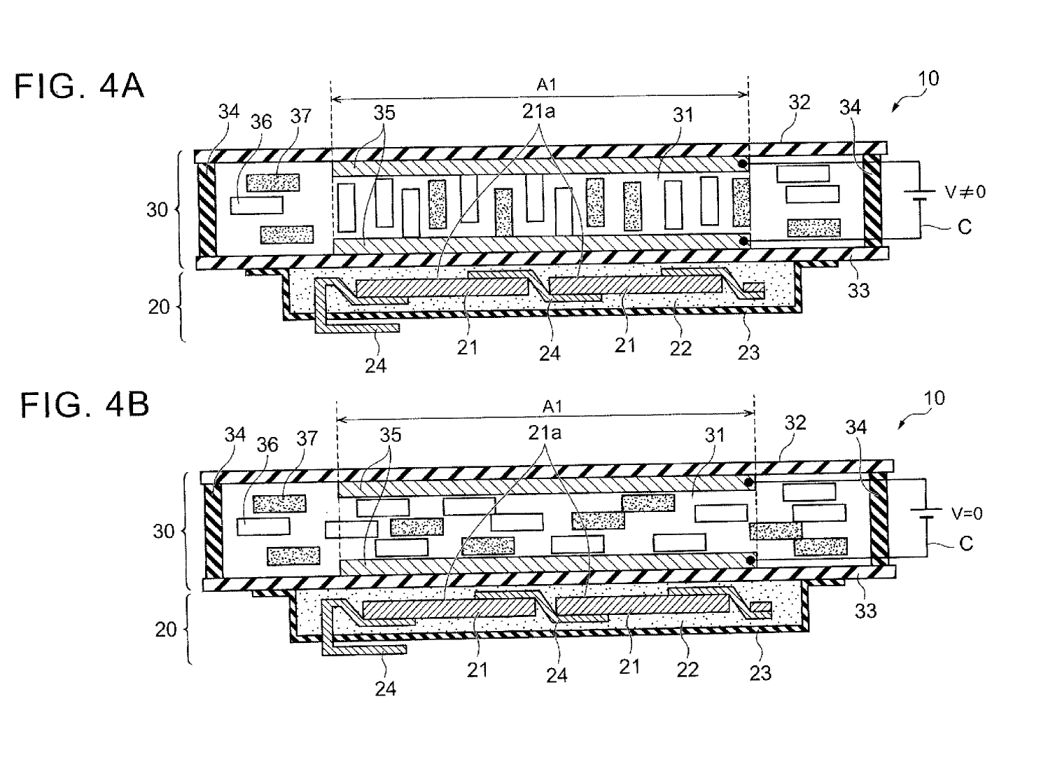

Referring next to FIG. 3 and FIGS. 4A and 4B, the operation of the solar cell module 10 according to one embodiment of the invention will be described.

FIG. 3 is a flowchart illustrating the operation of the solar cell module 10. FIGS. 4A and 4B show the operation of the solar cell module 10. The liquid crystal controller 42 of the solar cell module 10 executes a control routine as illustrated in FIG. 3 at given intervals.

The liquid crystal controller 42 reads the detection result received from the key sensor, and determines whether the door is locked (S11).

If it is determined in step S11 that the door is locked, the liquid crystal controller 42 reads the detection result received from the ignition sensor, and determines whether the engine is in operation (S12).

If it is determined in step S12 that the engine is in operation, the liquid crystal controller 42 reads the detection result received from the light sensor, and determines whether the amount of ambient light is equal to or larger than a given threshold value (S13). The threshold value of the amount of ambient light is set as the amount of ambient light with which the solar cell module 10 provides the minimum output or power, for example.

If it is determined in step S13 that the amount of ambient light is equal to or larger than the threshold value, the liquid crystal controller 42 reads the detection result received from the battery sensor, and determines whether the remaining battery charge is equal to or larger than a given threshold value (S14). The threshold value of the remaining battery charge is set to about 50% of the maximum capacity of the battery, for example.

If it is determined in step S14 that the remaining battery charge is equal to or greater than the threshold value, the liquid crystal controller 42 determines whether a voltage is applied to the liquid crystal layer 31 (S15). If it is determined that no voltage is applied to the liquid crystal layer 31, the liquid crystal controller 42 controls the voltage application circuit C, so as to start applying a voltage to the liquid crystal layer 31 via the transparent electrodes 35.

With the voltage thus applied to the liquid crystal layer 31, orientation changes or phase changes in the liquid crystal molecules 36 occur, in a change region A1 of the liquid crystal layer 31 located between the pair of transparent electrodes 35, 35, as shown in FIG. 4A. As a result, the transmittance is increased to be higher than that in the case where no voltage is applied to the liquid crystal layer 31, and scattering reflected light is reduced. Accordingly, the degree of transparency of the liquid crystal layer 31 is increased, and the light-receiving surface 21a located on the backside of the change region A1 is made highly visible.

When the liquid crystal layer 31 is configured to permit its color to be changed according to the transmittance, the color of the liquid crystal layer 31 becomes lighter, due to orientation changes or phase changes in the dichroism pigment molecules 37, and the dark-colored light-receiving surface 21a becomes highly visible. Accordingly, when the degree of similarity between the color of the light-receiving surface 21a and the color of the installation location L is low, the degree of harmony in terms of color between the light-receiving surface 21a and the installation location L is reduced.

Referring back to FIG. 3, when it is determined in step S11 that the door is not locked, it is determined in step S12 that the engine is not in operation, it is determined in step S13 that the amount of ambient light is smaller than the threshold value, or it is determined in step S14 that the remaining battery charge is smaller than the threshold value, the liquid crystal controller 42 determines whether a voltage is applied to the liquid crystal layer 31 (S17). If it is determined that a voltage is applied to the liquid crystal layer 31, the liquid crystal controller 42 controls the voltage application circuit C, so as to finish applying the voltage to the liquid crystal layer 31 (S18).

In this case, orientation changes or phase changes in the liquid crystal molecules 36 occur, in the change region A1 of the liquid crystal layer 31 located between the transparent electrodes 35, as shown in FIG. 4B. As a result, the transmittance is reduced to be lower than that in the case where a voltage is applied, and scattering reflected light is increased. Accordingly, the degree of transparency of the liquid crystal layer 31 is reduced, and the light-receiving surface 21a located on the backside of the change region A1 becomes less visible.

When the liquid crystal layer 31 is configured to permit its color to be changed according to the transmittance, the color of the liquid crystal layer 31 becomes darker, due to orientation changes or phase changes in the dichroism pigment molecules 37, and the dark-colored light-receiving surface 21a becomes less visible. Accordingly, when the degree of similarity between the color of the light-receiving surface 21a and the color of the installation location L is low, the degree of harmony in terms of color between the light-receiving surface 21a and the installation location L is increased.

In the control routine illustrated in FIG. 3, it is determined whether a voltage needs to be applied to the liquid crystal layer 31, using the locked state of the door, the operating state of the engine, the amount of ambient light, and the remaining battery charge as conditions. However, the above determination may be made in view of a part of these conditions or other conditions. For example, the state of voltage application may be changed according to an operating state of a switch, button, or the like, which can be operated by the driver of the vehicle, for example. Also, the order in which determinations regarding the conditions are made is not limited to the order shown in FIG. 3.

In the control routine illustrated in FIG. 3, the voltage is applied or not applied to the liquid crystal layer 31 depending on the above conditions. However, the applied voltage may be increased or reduced.

Next, a solar cell module 60 according to another embodiment of the invention will be described. In the following description, portions or elements that overlap those of the above-described embodiment will not be repeatedly described.

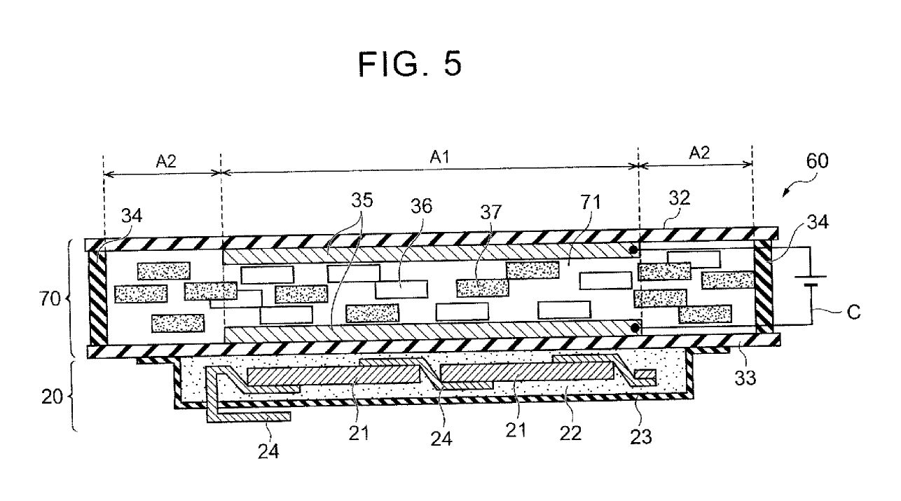

FIG. 5 is a cross-sectional schematic view showing a principal part of the solar cell module 60 according to another embodiment of the invention. In the solar cell module 60, a liquid crystal unit 70 is configured such that the color becomes darker toward a peripheral portion thereof.

The liquid crystal unit 70 of the solar cell module 60 is configured to permit its color to be changed according to the transmittance. To this end, in a liquid crystal layer 71, at least one kind of dichroism pigment molecules 37 for developing color having a high degree of similarity to the color of the installation location L are dissolved in the liquid crystal Molecules 36.

In the solar cell module 60, as shown in FIG. 5, the dichroism pigment molecules 37 are dissolved in the liquid crystal molecules 36 in non-change regions A2, A2 at opposite ends of the change region A1, in a higher proportion than that in the change region A1. Since the non-change regions A2 are located apart from the light-receiving surfaces 21a of the solar cells 21, the high concentration of the dichroism pigment molecules 37 does not affect the power generation efficiency.

With the above arrangement, as shown in FIG. 5, when no voltage is applied to the transparent electrodes 35, the color of the liquid crystal layer 71 becomes dark in the change region A1, and the color of the liquid crystal layer 71 becomes darker in the non-change regions A2, than that in the change region A1 As a result, the boundary between the solar cell module 60 and the installation location L is blurred, and the degree of harmony in terms of color between the solar cell module 60 and the installation location L is further increased.

As explained above, in the solar cell module 10, 60 according to each embodiment of the invention, the transmittance of light in the liquid crystal unit 30, 70 disposed on one side of the solar cells 21 facing the light-receiving surfaces 21a is controlled so as to control the visibility of the light-receiving surfaces 21a. Namely, the transmittance is increased so as to make the light-receiving surfaces 21a highly visible, and the transmittance is reduced so as to make the light-receiving surfaces 21a less visible. Consequently, it is possible to uncover or cover the external appearance of the solar cells 21, without requiring an opening/closing mechanism.

Also, the degree of transparency of the liquid crystal unit 30, 70 is adjusted so as to vary the visibility of the light-receiving surfaces 21a. Namely, the degree of transparency is increased so as to make the light-receiving surfaces 21a highly visible, and the degree of transparency is reduced so as to make the light-receiving surfaces 21a less visible.

Also, the color of the liquid crystal unit 30, 70 is controlled to the same or substantially the same color as that of the installation location L of the solar cell module 10, 60, and the color of the liquid crystal unit 30, 70 can be changed according to the transmittance. Thus, the degree of similarity to the installation location L is reduced so as to reduce the degree of harmony in terms of color between the liquid crystal unit 30, 70 and the installation location L, and the degree of similarity to the installation location L is increased so as to increase the degree of harmony.

Also, the transmittance in the liquid crystal unit 30, 70 is controlled, based on conditions or light-receiving conditions of an object on which the solar cell module 10, 60 is installed, so that the light-receiving surfaces 21a can be made less visible, or the color of the liquid crystal unit 30, 70 can be harmonized with the color of the installation location L, depending on the situation.

When the liquid crystal unit 70 is configured such that the color becomes darker toward its peripheral portion, the boundary between the solar cell module 60 and the installation location L is blurred, and the degree of harmony in terms of color between the liquid crystal unit 70 and the installation location L can be further increased.

With the solar cell module 10, 60 installed on the external surface of the vehicle, the light-receiving surfaces 21a can be made less visible, and the color of the light-receiving surfaces 21a can be harmonized with the color of the installation location L. Consequently, the design quality of the vehicle can be improved.

The embodiments as described above are the best ones of solar cell modules according to the invention, and the solar cell module according to the invention is not to be limited to those of the above-described embodiments. The solar cell modules according to the above embodiments may be modified without departing from the principle of the invention as stated in each of the appended claims, or may be applied to other objects.

For example, while the solar cell module 10, 60 is installed on the external surface of the vehicle in the above-described embodiments, the solar cell module 10, 60 may be installed on an external surface of an object other than vehicles. Also, the solar cell module 10, 60 is not necessarily installed on an external surface of an object, but may be installed alone. In this case, the color of the liquid crystal unit 30, 70 is controlled to the same or substantially the same color as that of the ambient environment, so that the degree of harmony in terms of color with the ambient environment can be increased.

What is claimed is:

1. A solar cell module, comprising:
a solar cell having a light-receiving surface;
a liquid crystal unit disposed on one side of the solar cell so as to face the light-receiving surface; and
a control unit that controls a transmittance of light in the liquid crystal unit.

2. The solar cell module according to claim 1, wherein the control unit controls a degree of transparency of the liquid crystal unit.

3. The solar cell module according to claim 1, wherein:
the liquid crystal unit is configured to permit a color of the liquid crystal unit to be changed according to the transmittance; and
the control unit is configured to control the color of the liquid crystal unit to the same or substantially the same color as a color of an installation location at which the solar cell module is installed.

4. The solar cell module according to claim 1, further comprising a detecting unit that detects at least one of conditions and light receiving conditions of an object on which the solar cell module is installed, wherein
the control unit is configured to control the transmittance in the liquid crystal unit, based on a detection result obtained by the detecting unit.

5. The solar cell module according to claim 1, wherein the liquid crystal unit is configured to assume a color that becomes darker toward a peripheral portion of the liquid crystal unit.

6. The solar cell module according to claim 1, which is installed on an external surface of a vehicle.
